(19) United States
(12) Patent Application Publication
(10) Pub. No.: US 2006/0094456 A1
(43) Pub. Date: May 4, 2006

(54) Device and method for service discovery in adhoc networks using beacon signalling

(76) Inventors: Loren J. Rittle, Naperville, IL (US); Nitya Narasimhan, Schaumburg, IL (US); Venugopal Vasudevan, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 10/977,107

(22) Filed: Oct. 29, 2004

(51) Int. Cl. H04B 7/00; H04Q 7/20

(52) U.S. Cl. 455/519; 455/517

(57) ABSTRACT

A wireless communication device (101) for direct communication with one or more near-proximity devices (111, 113) to form an adhoc network is provided. The wireless communication device comprises a transceiver (201) configured to send, via wireless link, a beacon signal. The beacon signal includes a device identifier (305) and a service map (307) associated with the wireless communication device. The service map identifies one or more applications (223, 225, 227) that may operate on the wireless communication device.

### FIELD OF THE INVENTION

The present invention relates generally to the field of adhoc networks for wireless communication devices. In particular, the present invention relates to

### BACKGROUND OF THE INVENTION

Wireless communication systems between mobile devices commonly utilize wireless infrastructure to route the communication and interconnect the devices. Many mobile devices are being equipped with wireless cellular networking interfaces that permit communication of voice and data content through a cellular infrastructure that includes a plurality of base station. Examples of technologies utilized by these mobile devices include analog communications (using AMPS), digital communications (using CDMA, TDMA, GSM, iDEN, GPRS, or EDGE), and next generation communications (using UMTS or WCDMA) and their variants. Other mobile devices are being equipped with short-range networking interfaces that permit communication of data packets through an infrastructure that includes a plurality of access points. Examples of technologies utilized by these other mobile device include router-based communications of IEEE 802.11 (a, b or g).

Other types of wireless communication systems between mobile devices are capable of peer-to-peer communication over an adhoc network. Examples of technologies utilized by these mobile devices of adhoc networks include Bluetooth (IEEE 802.15) and the independent basic service set (IBSS) mode of IEEE 802.11. These mobile devices are particularly attractive for certain uses since they do not require any type of router or infrastructure to support their communications.

Some wireless communications systems may switch between two modes of operations. For example, the IEEE 802.11 wireless communication standard is an example of a communication protocol that may operate in an infrastructure mode and an adhoc (IBSS) mode. In the infrastructure mode, all communication traffic between devices passes through an access point. In adhoc mode, devices communicate directly to each other and do not require any type of access point.

Unfortunately, existing systems and methods for establishing adhoc networks are not efficient or perform adequately enough for certain types of applications, such as communications required between tribal applications. In particular, the act of establishing IP channels in an adhoc network requires tedious pre-configuration which is unacceptable in tribal application markets. Accordingly, there is a need for an adhoc system and method that operates efficiently, and is more tightly bound, with adhoc networking protocols.

### BRIEF DESCRIPTION OF THE DRAWINGS

FIG. 1 is a schematic diagram of an exemplary system of an adhoc network in accordance with the present invention.

FIG. 2 is a block diagram representing various components of a mobile device of the adhoc network of FIG. 1.

FIG. 3 is a timing diagram illustrating an exemplary format of a beacon signal transmitted by an initiating mobile device in accordance with the present invention.

FIG. 4 is a flow diagram of an exemplary operation of a mobile device of the adhoc network of FIG. 1.

### DETAILED DESCRIPTION OF THE PREFERRED EMBODIMENTS

One aspect of the present invention is a method of a wireless communication device for direct communication with one or more near-proximity devices to form an adhoc network. A beacon signal, transmitted via a wireless link, includes a device identifier and a service map associated with the wireless communication device. The service map identifies one or more applications that may operate on the wireless communication device.

Another aspect of the present invention is a wireless communication device for direct communication with one or more near-proximity devices to form an adhoc network. The wireless communication device comprises a transceiver configured to send, via wireless link, a beacon signal. The beacon signal includes a device identifier and a service map associated with the wireless communication device. The service map identifies one or more applications that may operate on the wireless communication device.

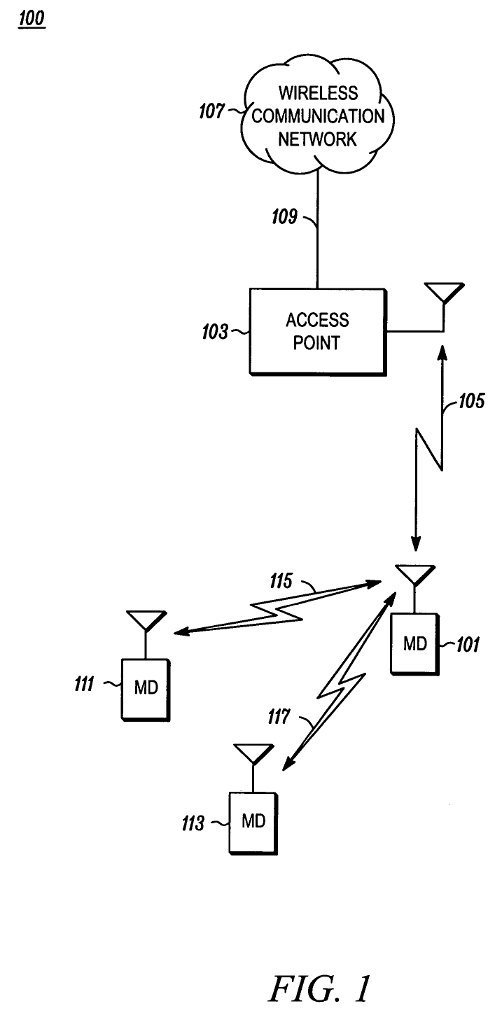

Referring to FIG. 1, a wireless communication system 100 may include a plurality of mobile devices 101 that operates in an infrastructure mode, an adhoc mode, or both. For infrastructure mode, each mobile device 101 may communicate with one or more access points 103 infrastructure mode, the mobile device may communicate with one or more base stations or access points 103 via a wireless communication link 105. The wireless communication link 105 utilizes a short-range communication protocol, such as IEEE 802.11, IEEE 802.15 (Bluetooth), HomeRF, Infrared, and the like. Optionally, each mobile device 101 may also communicate using a longer-range communication protocol, such as analog communications (using AMPS), digital communications (using CDMA, TDMA, GSM, iDEN, GPRS, or EDGE), and next generation communications (using UMTS or WCDMA) and their variants. Each access point 103, in turn, may communicate with a communication network 107 via a wired or wireless communication link 109. The mobile stations 101 linked to the access point 103 may communicate with devices linked to other access points so long as they communicate with the wireless communication network 107.

For adhoc mode, each mobile station 101 may communicate with other mobile stations 111, 113 within direct, short-range communication range of itself. As shown in FIG. 1, a first mobile station 101 directly communicates with second and third mobile stations 111, 113, via wireless communication links, 115, 117, respectively, to form an adhoc network. The wireless communication links 115, 117 utilizes a short-range communication protocol, such as IEEE 802.11, IEEE 802.15 (Bluetooth), HomeRF, Infrared, and the like.

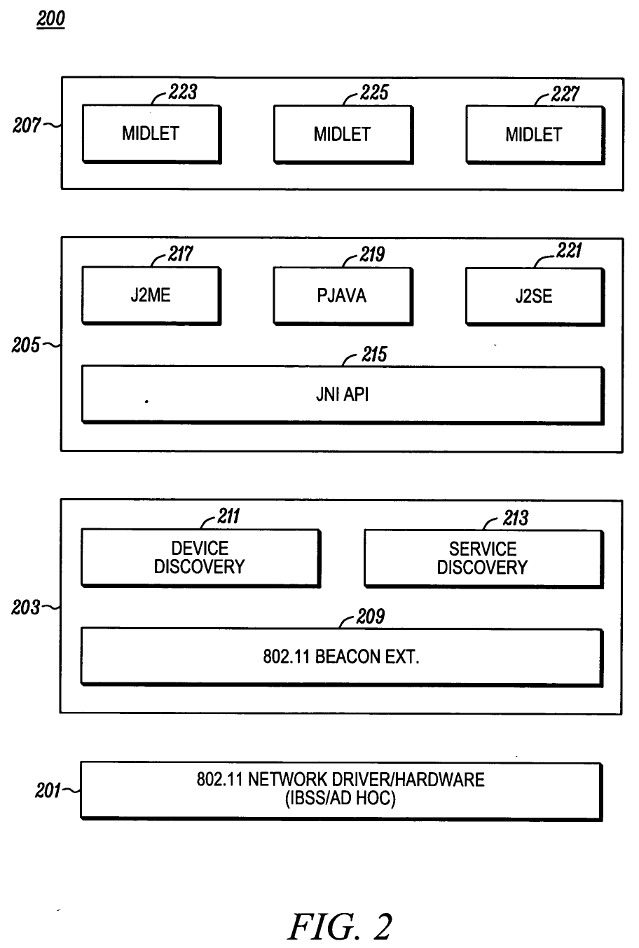

Referring to FIG. 2, there is provided various components 200 of an exemplary mobile device of an adhoc network. It is to be understood that each mobile device may have infrastructure communication capabilities as well as adhoc communication capabilities, even though components for such communication are not shown in FIG. 2. The components 200 of the exemplary mobile device include a physical layer 201, a discovery layer 203, an application programming interface (API) layer 205, and an application layer 207.

The physical layer 201 includes communication hardware and corresponding software for wireless communication of data directly with one or more peer devices. As stated above, the wireless communication may be based on a short-range communication protocol and may also utilize a longer-range communication protocol. For example, as shown in FIG. 2, the physical layer 201 may include IEEE 802.11 compliant circuitry for communication in IBSS mode and a corresponding IEEE 802.11 network driver for adapting the circuitry to the other components of the mobile device.

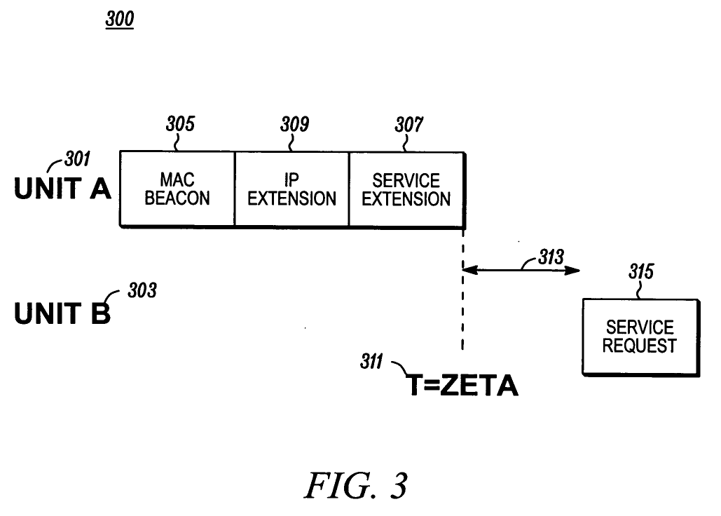

The discovery layer 203 is supported by, and operates above, the physical layer 201. The discovery layer 203 includes a set of protocols responsible for maintaining order in the use of a shared medium. As shown in FIG. 2, the discovery layer 203 includes a beacon extension component 209 (discussed below in relation to FIG. 3) as well as a device discovery component 211 and a service discovery component 213. The device discovery component 211 performs the operations necessary to scan a vicinity of the mobile device, within a communication range of the components of the physical layer 201, for one or more peer devices that may communicate with the mobile device to form an adhoc network. The service discovery component 213 performs the operation necessary to scan one or more areas of memory of the mobile device for applications currently operating in the mobile device and/or applications that may operated by the mobile device.

The API layer 205 is supported by, and operates above, the discovery layer 203 and, likewise, the application layer 207 is supported by, and operates above, the API layer. The API layer 205 includes one or more API's for configuring the discovery layer 203 for interpreting and otherwise supporting operations requested by applications of the application layer 207. The API must have at least one API to perform this function but may also include one or more sub-API's to support specific types of applications. For example, the API layer 205 may include a Java Native Interface (JNI) API 215 and one or more sub-API's, such as a Java 2 Platform Micro Edition (J2ME) API 217, a personal Java Platform (pJava) API 219, and/or a Java 2 Platform Standard Edition (J2SE) API 221.

The application layer 207 includes one or more applications 223, 225, 227 in a format supported by one or more API's of the API layer 205. For example, for the exemplary components shown in FIG. 2, the application layer 207 may includes a midlet 223 of the J2ME environment that is supported by the J2ME API 217 and JNI API 215. Although the exemplary components shown in FIG. 2 support variants of the Java environment, it is to be understood that the present invention supports a variety of application environments that may be implemented by a mobile device, such as C# or a native application environment.

Referring to FIG. 3, there is provided a timing diagram 300, between two units or devices 301, 303, illustrating an exemplary format of a beacon signal 305, 307 transmitted by an initiating mobile device. The present invention utilizes an adhoc network protocol as a carrier for device and service discovery information to enable device and service federation. In particular, a beaconing process is utilized, which accommodates a non-routable IP address for use of the single-hop network segment by any available scheme. Upon each allocation, the mobile device providing a beacon signal 305, 307 updates an internally-stored table. When the mobile device transmits the beacon signal 305, 307, the table is attached to the beacon signal and may be received by peer device within receiving range. Alternatively, the table may be split so that only a portion is sent with each beacon signal 305, 307. As an option, the beacon signal 305, 307 may retain service announcement information about possible peers in addition to device information. As another option, only signaling addresses are shared and no IP addresses are revealed. In this mode, only non-IP messages may be exchanged.

As shown in FIG. 3, the beacon signal transmitted by Unit A 301 may include a beacon identification 305 and a service extension 307. For example, the beacon identifier 305 may be a MAC beacon for an IEEE 802.11 adhoc network and the service extension 307 may include a map of applications currently operated by the mobile device and/or applications that may be operated by the mobile device. For one embodiment, the mobile device includes a Java Application Manager (JAM) that includes a registry of all applications loaded on the device. Primary service information may be extracted from Java Application Description (JAD) files that are registered within the JAM. Secondary service information may be associated with the active application working set. Upon each beacon frame associated with each beacon signal generated and transmitted, the service extension 307 is attached to include all or a portion of the primary and secondary service information. For one embodiment, each record of service information may include a service name and a port number, such as a TCP port number. For another embodiment, only the port number is present. For yet another embodiment, the secondary records are annotated. At the end of a beacon signal 305, 307 transmission at t=zeta 311, the mobile device waits for a certain time period 313 before a service request 315 may be received from another device, i.e., Unit B 303.

The beacon signal 305, 307 may be restricted in size. If the entire service map of a mobile device will not fit in one limited-size field of a service extension 307, then the transmitted portions may be annotated. Any standard round-robin technique to split and transmit the entire service information may be used.

The beacon signal 305, 307 may further include, but is not limited to, an IP extension 309, a frame control field, a duration/ID field, address fields, a sequence control field, a frame body field, and a frame check sequence field. The frame body may include a time stamp, a beacon interval, capability information and/or other information that include identification, length and content.

Turning now to another peer in the population, upon reception of any service information annotated beacon frame from a beacon signal 305, 307, the information may be decoded and used to update a known-service registry. Subsequently, when a local application is looking for a remote service, it may consult this known-service registry. If a beacon signal 305, 307 is determined to be missing over time, then related service information should be removed from the known-service registry. In alternative embodiments, other aging and sizing policies may be used to maintain the known-service registry. Secondary information may be retained in the known-service registry to aid these policies, such as the time the beacon was last seen or updated.

For another embodiment, the mobile device incrementally fulfills application requests to discover services as service information annotated beacon frames are received and, thus, no known-service registry is maintained. This embodiment is particularly useful when aggressive duty cycling is applied to each device.

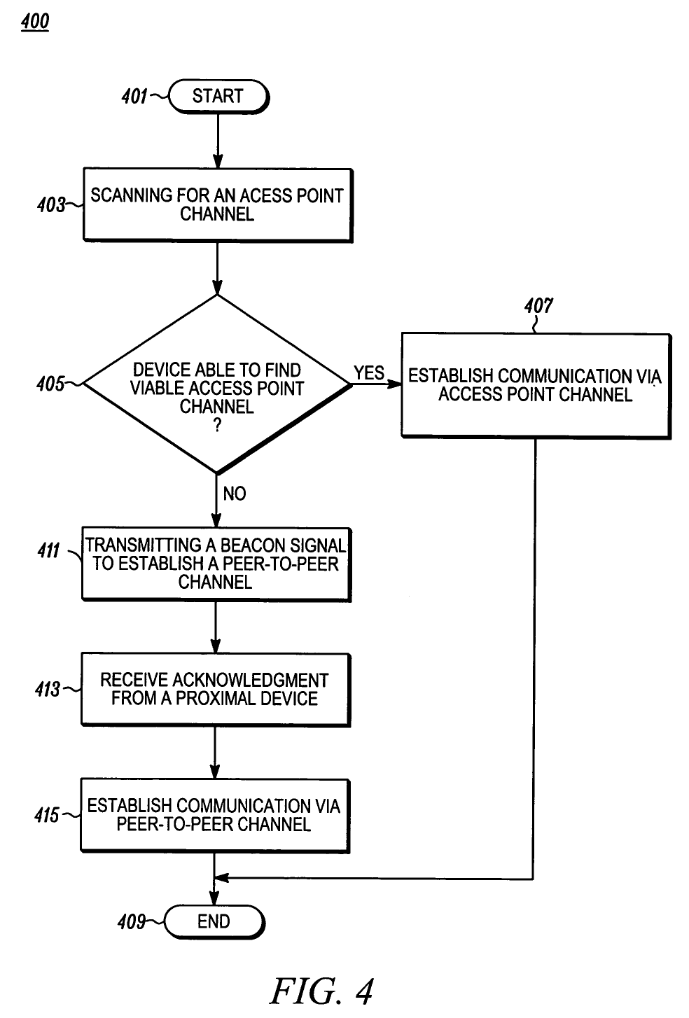

Referring to FIG. 4, there is provided a flow diagram of an exemplary operation 400 of a mobile device of the adhoc network. The adhoc network, i.e., wireless system for peer-to-peer communication, of the present invention may specify various frame formats to be used for both management and data transfer operations. Data frames may include IP packets, and management frames may include beacon frames. When a mobile device desires to participate in an adhoc network with one or more other peer devices, the mobile device may scan known physical channels to determine whether there are any existing adhoc networks within its vicinity. In particular, the mobile device may initiate participation in an existing adhoc network if it detects a beacon signal from a peer device within adhoc network communication range of the mobile device. Upon reception of a compatible beacon frame, a nominal sub-state is assumed and channel parameters for communication in the adhoc network are as implied by the received beacon frame. If no compatible beacon frame is received before a predetermined timeout period expires, then the nominal sub-state is assumed and the mobile device transmits a beacon frame including channel parameters in order to initiate an adhoc network.

Starting at step 401, the mobile device scans for an access point channel at step 403. The mobile device then determines whether a viable access point channel is found at step 405. If a viable access point channel is found at step 405, then communication is established with one or more other devices via the access point channel at step 407 and the exemplary operation 400 terminates at step 409. Otherwise, if a viable access point channel is not found at step 405, then the mobile station transmits a beacon signal to establish a peer-to-peer channel for an adhoc network at step 411. For example, the first mobile station to be active for an adhoc network may establish an IBSS and starts sending beacon signals, which are needed to maintain synchronization among devices. Other peer devices may join the adhoc network after receiving the beacon signal and accepting the parameters (e.g., beacon interval) found in the beacon frame of the signal. In particular, the mobile station awaits acknowledgment of the beacon signal from a peer device within its proximity, i.e., within direct communication range of its transceiver, at step 413. In the preferred embodiment, this acknowledgement is a TCP SYN packet. After receiving the acknowledgment, the mobile station may establish communication with the responding peer device via the peer-to-peer channel at step 415. Then, the exemplary operation 400 terminates at step 409.

For another embodiment, steps 403, 405, and 407 are removed. Starting at step 401, the mobile station transmits a beacon signal to establish a peer-to-peer channel for an adhoc network at step 411.

All peer devices that join the adhoc network send a beacon periodically if it does not detect a beacon signal from another device within a short random delay period after the beacon signal is supposed to have been sent. The random delay period minimizes the transmission of beacon signals from multiple stations by effectively reducing the number of stations that will send a beacon signal. If a peer device does not detect a beacon signal within the random delay period, then the mobile device assumes that no other peer devices are active and a beacon signal needs to be transmitted.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of a wireless communication device for direct communication with one or more near-proximity devices to form an adhoc network, the method comprising:
transmitting, via wireless link, a beacon signal including a device identifier and a service map associated with the wireless communication device, the service map identifying at least one application that may operate on the wireless communication device.

2. The method of claim 1, wherein transmitting a beacon signal via wireless link includes transmitting the beacon signal via the wireless link utilizing an adhoc network protocol.

3. The method of claim 2, wherein the adhoc network protocol is based on an IEEE 802.11 protocol.

4. The method of claim 1, wherein the at least one application that may operate on the wireless communication device includes at least one application stored by the wireless communication device.

5. The method of claim 1, wherein the service map identifies all applications that may operate on the wireless communication device.

6. The method of claim 5, wherein the applications identified by the service map include at least one application stored by the wireless communication device.

7. The method of claim 1, further comprising scanning for an access point channel.

8. The method of claim 7, further comprising attempting to establish a peer-to-peer channel if the wireless communication device is unable to find a viable access point channel.

9. The method of claim 8, further comprising receiving an acknowledgment from at least one near proximity device in response to transmitting the beacon signal.

10. The method of claim 1, wherein the device identifier includes an IP address associated with the wireless communication device.

11. A wireless communication device for direct communication with one or more near-proximity devices to form an adhoc network, the wireless communication device comprising:
a transceiver configured to send, via wireless link, a beacon signal including a device identifier and a service map associated with the wireless communication device, the service map identifying at least one application that may operate on the wireless communication device.

12. The wireless communication device of claim 11, wherein the wireless link utilizes an adhoc network protocol.

13. The wireless communication device of claim 12, wherein the adhoc network protocol is based on an IEEE 802.11 protocol.

14. The wireless communication device of claim 11, further comprising a memory portion configure to store the at least one application.

15. The wireless communication device of claim 11, wherein the service map identifies all applications that may be operated by the wireless communication device.

16. The wireless communication device of claim 15, wherein the applications identified by the service map include at least one application stored in a memory portion of the wireless communication device.

17. The wireless communication device of claim 11, wherein the transceiver scans for an access point channel.

18. The wireless communication device of claim 17, wherein the transceiver attempts to establish a peer-to-peer channel if the transceiver is unable to find a viable access point channel.

19. The wireless communication device of claim 18, wherein the transceiver receives an acknowledgment from at least one near proximity device in response to sending the beacon signal.

20. The wireless communication device of claim 11, wherein the device identifier includes an IP address associated with the wireless communication device.
